(19) United States
(12) Patent Application Publication
(10) Pub. No.: US 2018/0281157 A1
(43) Pub. Date: Oct. 4, 2018

(54) FIXING SYSTEM USED IN WET PROCESS

(71) Applicant: HON HAI PRECISION INDUSTRY CO., LTD., New Taipei (TW)

(72) Inventors: YEA-CHIN YEH, New Taipei (TW); I-THUN LIN, Tu-Cheng (TW); CHUN-MING HUANG, New Taipei (TW); MING-CHI CHEN, New Taipei (TW)

(21) Appl. No.: 15/809,179

(22) Filed: Nov. 10, 2017

(30) Foreign Application Priority Data
Mar. 30, 2017 (TW) 106110659

(51) Int. Cl. B25B 11/00

(52) U.S. Cl. CPC B25B 11/005

(57) ABSTRACT

A fixing system used in a wet process includes a platform, wherein the platform defines a concavity on the top of the platform, a chamber on the bottom of the platform, and a number of sucking holes inside of the platform, the concavity and the chamber are intercommunicated with each other by the number of sucking holes; and a pumping device connected to the chamber and configured to exhaust the gas. The fixing system further includes a container, the container is connected to the pumping device by a first pipe and connected to the chamber by a second pipe. Solution leaked from the through holes is collected by the container and does not enter the pumping device.

### CROSS-REFERENCE TO RELATED APPLICATIONS

This application claims all benefits accruing under 35 U.S.C. § 119 from Taiwan Patent Application No. 106110659, filed on Mar. 30, 2017, in the Taiwan Intellectual Property Office, the contents of which are hereby incorporated by reference.

### BACKGROUND

### 1. Technical Field

The present disclosure relates to wet process technology, and particularly, to a fixing system for sucking the object plate.

### 2. Description of Related Art

In a wet process, the object plate is usually fixed by sucking holes defined by the platform and under the object plate.

However, when the object plate is immersed in a solution, some of the solution would leak through the sucking holes in the process of creating a vacuum in the sucking holes. The leaked solution would enter the pump device and cause the pump device to be broken. Especially, when the object plate is immersed in an organic solvent, it is very hard to prevent the organic solvent from leaking.

What is needed, therefore, is to provide a fixing system used in a wet process that can overcome the problems as discussed above.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiments. Moreover, in the drawings, like reference numerals designate corresponding parts throughout the several views.

FIG. 1 is a schematic view of one exemplary embodiment of a fixing system used in a wet process.

FIG. 2 is a schematic view of one exemplary embodiment of a container.

FIG. 3 is a cross sectional view, along lines of FIG. 2.

FIG. 4 is a schematic view of another one exemplary embodiment of the container.

FIG. 5 is a schematic view of another one exemplary embodiment of a fixing system used in a wet process.

FIG. 6 is a schematic view of another one exemplary embodiment of a fixing system used in a wet process.

FIG. 7 is a schematic view of another one exemplary embodiment of a fixing system used in a wet process.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to considered as limiting the scope of the exemplary embodiments described herein.

Several definitions that apply throughout this disclosure will now be presented. The terms “connected” and “coupled” are defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” exemplary embodiment in this disclosure are not necessarily to the same exemplary embodiment, and such references mean at least one.

References will now be made to the drawings to describe, in detail, various exemplary embodiments of the present fixing systems used in a wet process.

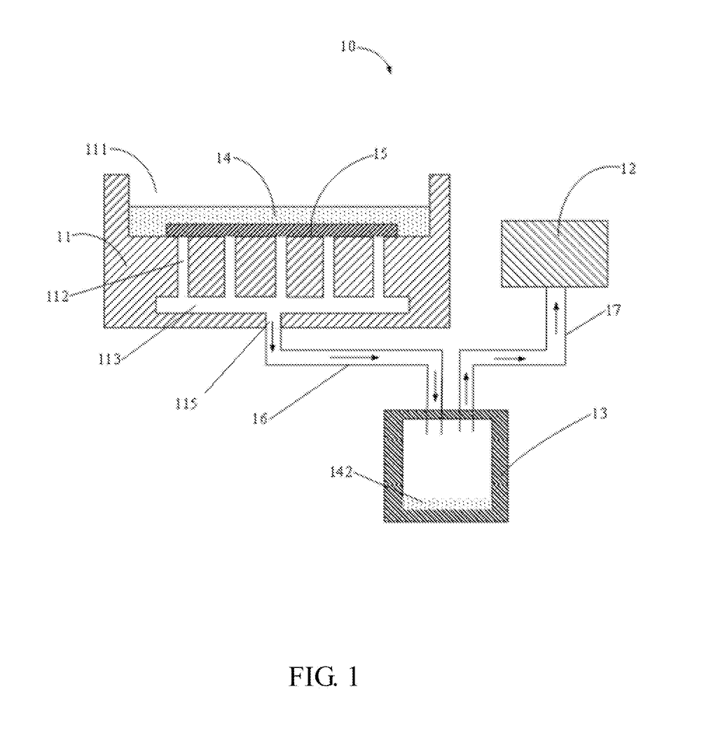

Referring to FIG. 1, a fixing system 10 used in a wet process of one exemplary embodiment is provided. The fixing system 10 includes a platform 11, a pumping device 12, and a container 13.

The platform 11 defines a concavity 111 on the top of the platform 11, a chamber 113 at the bottom of the platform 11, and a plurality of sucking holes 112 inside of the platform 11. The concavity 111 and the chamber 113 are intercommunicated with each other by the plurality of sucking holes 112. The concavity 111 can accommodate a solution 14 and an object plate 15. The plurality of sucking holes 112 can fix the object plate 15 by sucking. The chamber 113 is connected to the container 13 by a first pipe 16. The pumping device 12 is connected to the container 13 by a second pipe 17. Thus, the pumping device 12 is connected to the plurality of sucking holes 112. The pumping device 12 can evacuate the plurality of sucking holes 112 so that the object plate 15 can be sucked on the platform 11 by the atmospheric pressure. During evacuating the plurality of sucking holes 112, some of the solution 14 would leak from the concavity 111 through the plurality of sucking holes 112 to form a leaked solution 142. The leaked solution 142 would be collected by the container 13, retained at the bottom of the container 13, and would not enter the pumping device 12.

The platform 11 can be a metal structure made by pouring technology. The shape and size of the concavity 111 and the chamber 113 are not limited and can be designed according to need. The diameter, number, and arrangement of the plurality of sucking holes 112 are also not limited and can be designed according to need. In one exemplary embodiment, the concavity 111 is a rectangular concavity having a planar bottom surface, the chamber 113 is a rectangular space having a first through hole 115 at the bottom. The plurality of sucking holes 112 are cylindrical and vertically extend from the concavity 111 to the chamber 113.

The first pipe 16 includes a first end and a second end opposite to the first end. The first end is connected to the first through hole 115, and the second end is connected to and extends inside of the container 13. The second pipe 17 includes a third end and a fourth end opposite to the third end. The third end is connected to the pumping device 12, and the fourth end is connected to and extends inside of the container 13. In one exemplary embodiment, both the first pipe 16 and the second pipe 17 are inserted into the container 13 from the top cover and spaced apart from the bottom of the container 13. The top cover can be a rubber stopper to seal the container 13 and prevent gas from leaking. Both the first pipe 16 and the second pipe 17 penetrate the rubber stopper. The pumping device 12 can be a mechanical pump, a molecular pump, or an ion pump.

The shape and size of the container 13 are not limited and can be designed according to need. The material of the container 13 can be glass, ceramic, polymer, or metal. The container 13 can be transparent so that the leaked solution 142 in the container 13 can be observed. In one exemplary embodiment, the container 13 is a glass bottle. In operation of the fixing system 10, the container 13 is kept as vacuum because the container 13 is connected to the pumping device 12.

When the container 13 is filled with too much leaked solution 142, the leaked solution 142 need to be discharged from the container 13 so that the ends of the first pipe 16 and the second pipe 17 do not touch the leaked solution 142. Thus, the operation of the fixing system 10 has to be stopped. In order to discharge the leaked solution 142 from the container 13 during the operation of the fixing system 10, the container 13 can include a separator as described below.

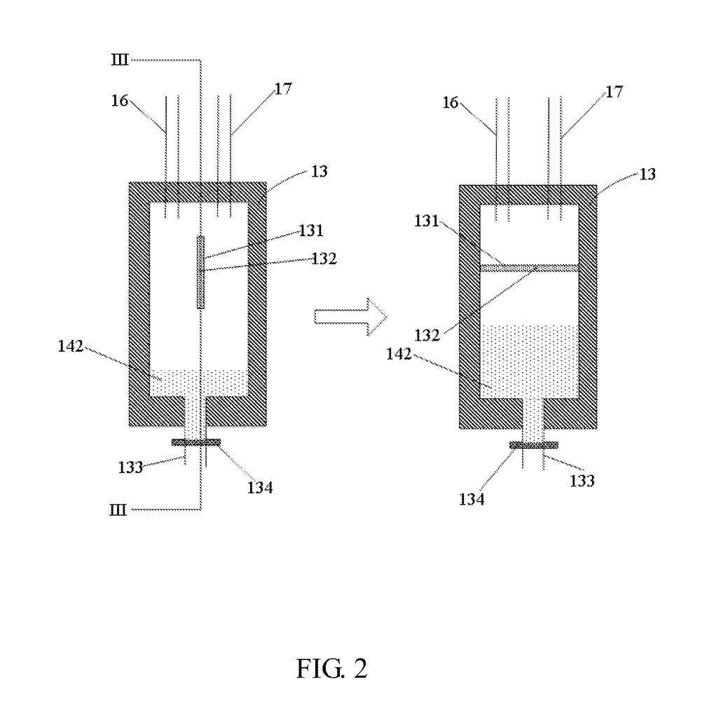

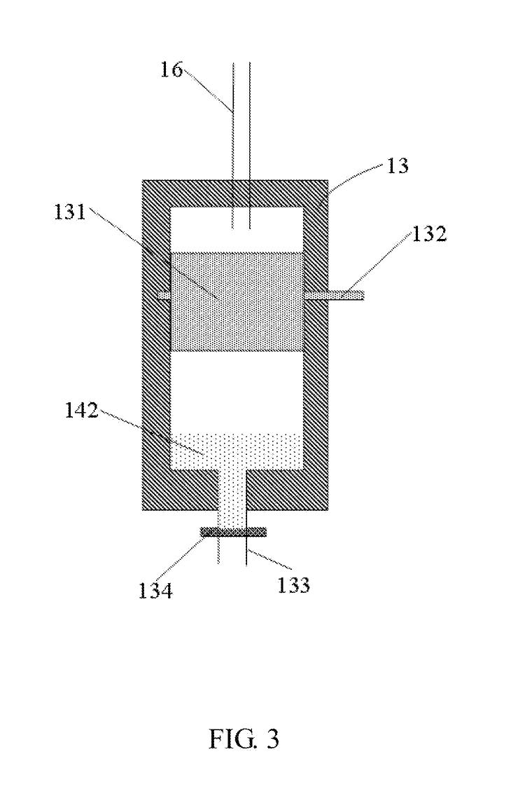

Referring to FIGS. 2-3, in one exemplary embodiment, the separator is a separating plate 131 located in the container 13. The separating plate 131 is rotatable so that the inner space of the container 13 can be separated to a top space and a bottom space. The leaked solution 142 is located in the bottom space. The shape and size of the separating plate 131 is the same as the shape and size of the section of the container 13. The separating plate 131 is fixed on the container 13 by an axis 132. The axis 132 is inserted in the wall of the container 13, and at least one end of the axis 132 extends out of the container 13. Thus, the separating plate 131 can be rotated by twisting the portion of the axis 132 that is outside of the container 13. The edge of the separating plate 131 can be further coated with a rubber layer to seal the bottom space. Furthermore, the container 13 includes a drainpipe 133 connected to the bottom space and a first valve 134 located on the drainpipe 133.

When the container 13 is separated to the top space and the bottom space by the separating plate 131, the first valve 134 can be open. Thus, the leaked solution 142 in the bottom space can be drained through the drainpipe 133. Because the top space and the bottom space are completely separated, the fixing system 10 can be operated in the process of draining the leaked solution 142. After the leaked solution 142 is drained, the separating plate 131 is rotated so that the top space and the bottom space are intercommunicated with each other again.

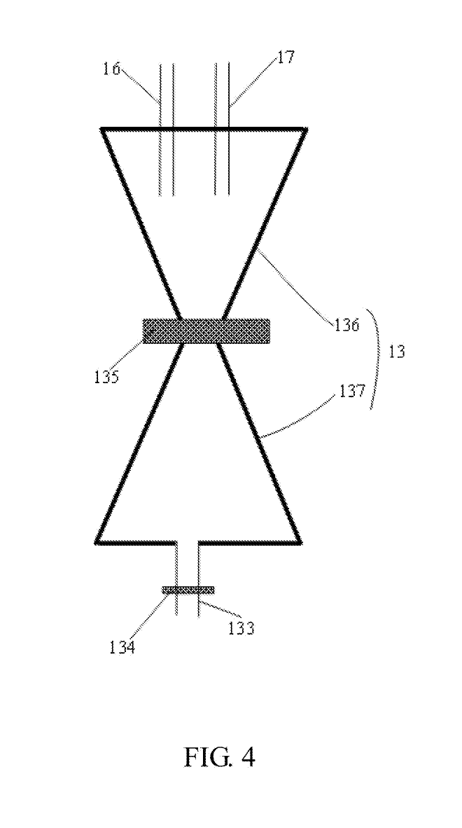

Referring to FIG. 4, in one exemplary embodiment, the container 13 includes a first vessel 136 and a second vessel 137, such as two flasks. The first vessel 136 and the second vessel 137 are connected to each other by a second valve 135 located at the junction. When the second valve 135 is closed, the container 13 is separated to the top space and the bottom space. Furthermore, the container 13 includes a drainpipe 133 connected to the bottom space of the second vessel 137 and a first valve 134 located on the drainpipe 133. Alternatively, the second vessel 137 is separable from the first vessel 136 and the second valve 135. When the second vessel 137 is fully filled with the leaked solution 142, the second valve 135 is closed, and then the second vessel 137 can be separated from the first vessel 136 to pour away the leaked solution 142. The second vessel 137 can be joined to the first vessel 136 again after the leaked solution 142 is removed.

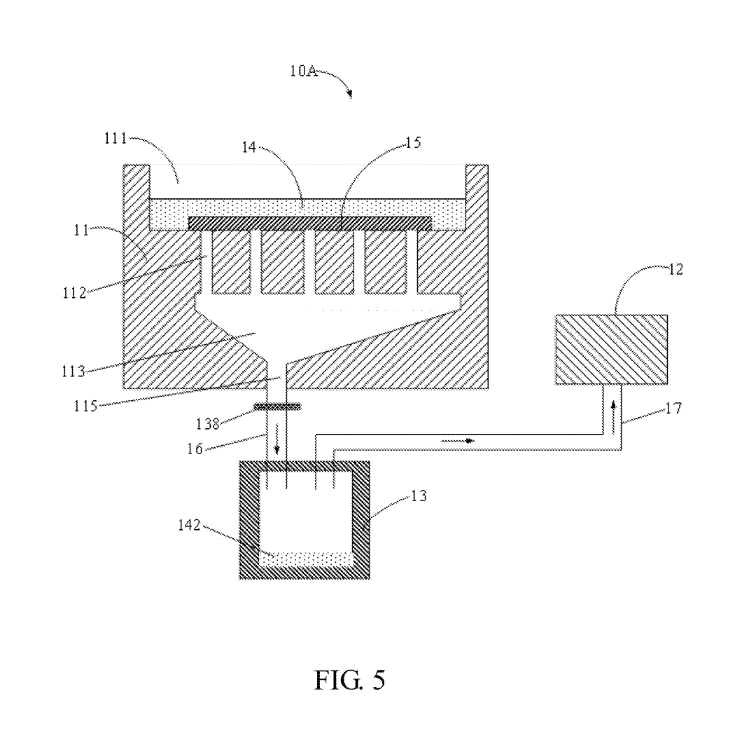

Referring to FIG. 5, a fixing system 10A used in a wet process of another one exemplary embodiment is provided. The fixing system 10A includes a platform 11, a pumping device 12, and a container 13. The container 13 is connected to the platform 11 by a first pipe 16 and to the pumping device 12 by a second pipe 17.

The fixing system 10A is similar to the fixing system 10 described above except that the bottom of the chamber 113 is funnel-shaped, the first through hole 115 is located at the lowest position of the chamber 113, and a third valve 138 is located on the first pipe 16.

In one exemplary embodiment, the container 13 is under the chamber 113 and opposite to the first through hole 115. The first pipe 16 is straight and vertically extends from the first through hole 115 into the inside of the container 13. Because the bottom of the chamber 113 is funnel-shaped and the first pipe 16 is vertical and straight, the leaked solution 142 can directly flow into the container 13 through the first pipe 16 under the action of gravity. When the container 13 is filled with too much leaked solution 142, the third valve 138 is closed, then the container 13 can be separated from the first pipe 16 and the second pipe 17 to pour away the leaked solution 142. The container 13 can be connected to the first pipe 16 and the second pipe 17 again after the leaked solution 142 is removed.

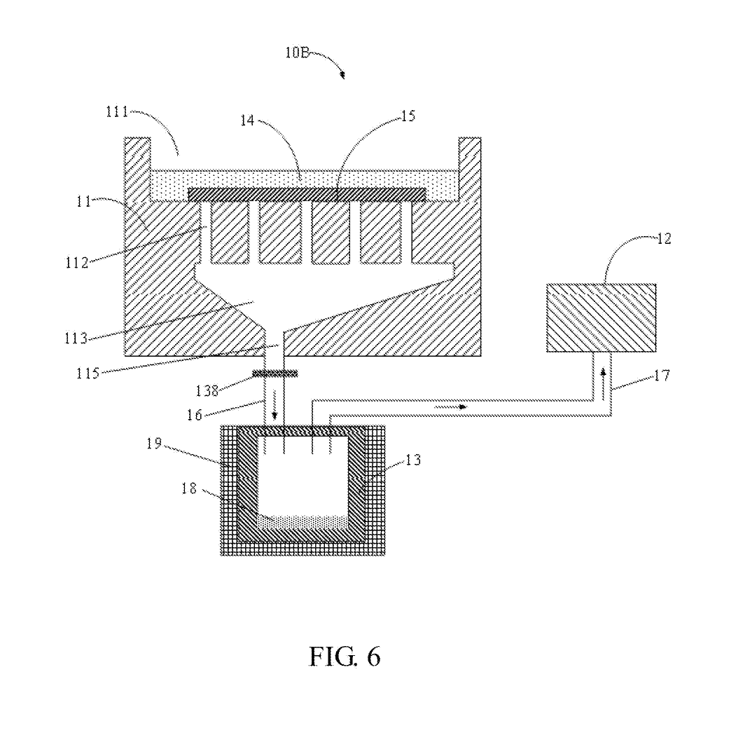

Referring to FIG. 6, a fixing system 10B used in a wet process of another one exemplary embodiment is provided. The fixing system 10B includes a platform 11, a pumping device 12, and a container 13. The container 13 is connected to the platform 11 by a first pipe 16 and to the pumping device 12 by a second pipe 17.

The fixing system 10B is similar to the fixing system 10A described above except that a liquid absorption material 18 is located in the container 13, and a cooling device 19 is located around the container 13.

Because the container 13 is kept as vacuum in the operation of the fixing system 10B, the leaked solution 142 in the container 13 is easily to volatilize. The liquid absorption material 18 and/or the cooling device 19 can prevent the leaked solution 142 from volatilizing. The liquid absorption material 18 can absorb the leaked solution 142, and the cooling device 19 can cool the leaked solution 142 or solidify the volatilized gas of the leaked solution 142. The liquid absorption material 18 can be sponge or cotton. The cooling device 19 can be a refrigerator, an ice block, or a tank of liquid nitrogen. The liquid absorption material 18 or the cooling device 19 can be omitted.

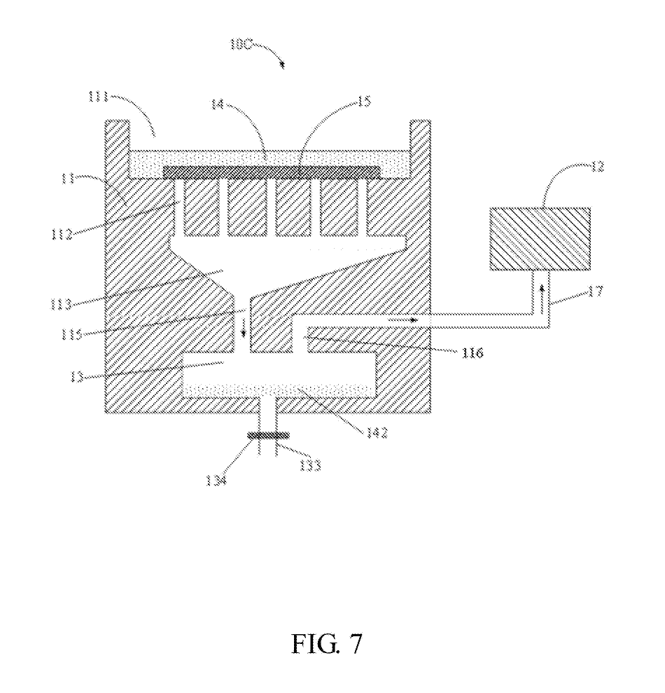

Referring to FIG. 7, a fixing system 10C used in a wet process of another one exemplary embodiment is provided. The fixing system 10C includes a platform 11, a pumping device 12, and a container 13. The fixing system 10C is similar to the fixing system 10A described above except that the container 13 is defined by the platform 11 and located under the chamber 113. The container 13 is intercommunicated with the chamber 113 directly by the first through hole 115. A second through hole 116 is defined by the platform 11 and located at the top of the container 13. The first pipe 16 is omitted, and the second pipe 17 is connected to the second through hole 116.

The fixing systems of this disclosure have following advantages. First, the container 13 can collect the leaked solution 142. Thus, the leaked solution 142 would not enter the pumping device 12. Second, the leaked solution 142 collected by the container 13 can be recycled. Third, the fixing systems are simple for operation and have low cost.

It is to be understood that the above-described exemplary embodiments are intended to illustrate rather than limit the disclosure. Any elements described in accordance with any exemplary embodiments is understood that they can be used in addition or substituted in other exemplary embodiments. Exemplary embodiments can also be used together. Variations may be made to the exemplary embodiments without departing from the spirit of the disclosure. The above-described exemplary embodiments illustrate the scope of the disclosure but do not restrict the scope of the disclosure.

Depending on the exemplary embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A fixing system used in a wet process, comprising:
a platform, the platform defining, at least:
a concavity on the top of the platform,
a chamber at the bottom of the platform, and
a plurality of sucking holes inside of the platform; and
the concavity and the chamber communicating with each other by the plurality of sucking holes;
a container, the container connected to the chamber by a first pipe; and
a pumping device, the pumping device connected to the container by a second pipe.

2. The fixing system of claim 1, wherein the both the first pipe and the second pipe are inserted into the container from a top cover of the container and spaced apart from the bottom of the container.

3. The fixing system of claim 1, the container comprises a separator, and the separator separates an inner space of the container to a top space and a bottom space.

4. The fixing system of claim 3, the container further comprises a drainpipe connected to the bottom space and a first valve located on the drainpipe.

5. The fixing system of claim 3, the separator is a rotatable separating plate located in the inner space of the container.

6. The fixing system of claim 3, the container comprises a first vessel and a second vessel joined with each other to form a junction, and the separator is a second valve located at the junction.

7. The fixing system of claim 6, wherein the second vessel is separable from the first vessel and the second valve.

8. The fixing system of claim 1, the bottom of the chamber being funnel-shaped, a first through hole is located at the lowest position of the chamber and connected to the first pipe.

9. The fixing system of claim 8, wherein a third valve is located on the first pipe.

10. The fixing system of claim 9, the container is under the chamber and opposite to the first through hole, and the first pipe is straight and vertically extends from the first through hole into the container.

11. The fixing system of claim 8, the container defined by the platform, located under the chamber, and directly communicating with the chamber directly by the first through hole.

12. The fixing system of claim 1, further comprising a liquid absorption material located in the container.

13. The fixing system of claim 12, wherein the liquid absorption material is sponge or cotton.

14. The fixing system of claim 1, further comprising a cooling device located around the container.

15. The fixing system of claim 14, wherein the cooling device comprises a refrigerator, an ice block, or a tank of liquid nitrogen.

16. A fixing system used in a wet process, comprising:
a platform, wherein the platform defines a concavity for accommodating an object plate and a plurality of sucking holes for sucking the object plate; and
a pumping device for evacuating the plurality of sucking holes, wherein the pumping device is connected to the platform through a container so that solution leaked from the plurality of sucking holes can be collected by the container and not enter the pumping device.
